(19) United States
(12) Patent Application Publication
(10) Pub. No.: US 2010/0181008 A1
(43) Pub. Date: Jul. 22, 2010

(54) MOLDING METHOD FOR EXPANDABLE POLYPROPYLENE

(75) Inventors: Eric Tang, Hong Kong (CN); Sidney Kwun Wa Leung, Macau (CN)

Correspondence Address: Workman Nydegger;1000 Eagle Gate Tower, 60 East South Temple, Salt Lake City, UT, 84111, US

(73) Assignee: Sidney Kwun Wa Leung, Macau (CN)

(21) Appl. No.: 12/690,676

(22) Filed: Jan. 20, 2010

(30) Foreign Application Priority Data
Jan. 21, 2009 (CN) 200910004873.9

(51) Int. Cl. B32B 3/10

(52) U.S. Cl. 156/78

(57) ABSTRACT

The present invention provides a vacuum thermoforming process-combined secondary molding method for expandable polypropylene, the method comprises the steps of silk screen printing on a blister sheet, vacuum thermoforming of the blister sheet to provide a thermoforming part, foam molding of expandable polypropylene to provide a EPP foam part, spray coating the surface of the EPP foam part with ink, and integrate molding of the EPP foam part and the thermoforming part. The expandable polypropylene blister product produced by this method exhibits good impact resistance and possesses good appearance.

### FIELD OF THE INVENTION

The present invention relates to a molding method for expandable polypropylene, especially to a vacuum thermoforming process-combined secondary molding method for expandable polypropylene.

### BACKGROUND OF THE INVENTION

Currently, foamed plastics have been widely applied in the fields of commodities, traffics, industrial productions, aeronautics and the like due to their superior properties such as low density, high specific strength, strong energy absorption ability and good performance in sound insulation and thermal insulation, etc.

In the manufacture of helmets such as those for bicycle, skiing/skating, ice hockey, mountain climbing, horse riding, aquatics, industrial uses, and the like, since there is a strict requirement for the strength of the final products, a vacuum thermoforming process is normally required for the expandable polypropylene plastic used in above products to further increase their strength.

Combination of the expandable polypropylene with the vacuum thermoforming process generally adopts a one-step integrate molding method, which involves an operation of placing a thermoforming part into a EPP shape molding mold, followed by incorporating expandable polypropylene and molding. Although the expandable polypropylene can combine well with the thermoforming part, this method may pose an adverse influence on the appearance of the product. The main reason is that both the pressure and the temperature for molding the expandable polypropylene are high, and the product may be affected as the temperature reaches 140° C. For example, the expandable polypropylene bead may mess up the silk-screen printing ink on the blister, and thus affect the appearance of the product and lead to a degradation of quality.

### SUMMARY OF THE INVENTION

In view of above problems in the prior art, an objective of the present invention is to provide a molding method for producing an expandable polypropylene blister product with good appearance.

In order to achieve the above objective, the present invention provides a molding method for expandable polypropylene, comprising a step of silk screen printing on a blister sheet and a step of vacuum thermoforming the blister sheet to provide a thermoforming part, said method further comprises the following steps:

(1) foam molding the expandable polypropylene to provide a EPP foam part;

(2) spray coating the surface of the EPP foam part obtained in step (1) with ink; and

(3) integrate molding the EPP foam part obtained in step (2) and the thermoforming part.

The ink used in step (2) of the molding method according to the present invention is preferably an ink for expandable polypropylene.

The expandable polypropylene used in step (1) of the molding method according to the present invention is preferably a modified expandable polypropylene.

The operating pressure for the integrate molding in step (3) of the molding method according to the present invention is preferably 80 kPa to 100 kPa, and the operating temperature is 140° C. or less.

The operating temperature for the integrate molding in step (3) of the molding method according to the present invention is preferably 120° C. to 130° C.

The operating time for the integrate molding in step (3) of the molding method according to the present invention is preferably 19 s to 25 s.

The advantages and beneficial effects of the secondary molding method according to the present invention lie in that the thus obtained expandable polypropylene blister product exhibits good impact resistance and possesses good appearance.

### BRIEF DESCRIPTION OF THE DRAWING

FIG. 1 is a flow chart showing the molding method for expandable polypropylene plastic in accordance with the present invention.

### DETAILED DESCRIPTION OF THE INVENTION

In order to further describe the principle and the structure of the present invention, detailed description of the preferred examples of the present invention will be made in reference to the accompanying drawing. However, said examples are only provided for illustration and explanation, which cannot be considered as a limitation of the protection scope of the present application.

### EXAMPLE 1

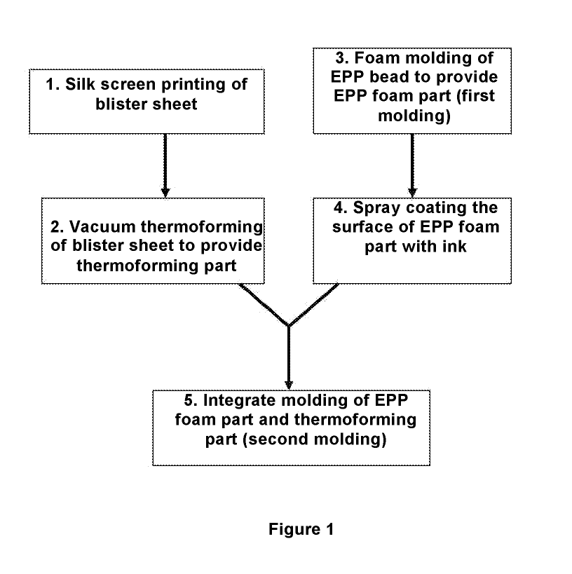

The molding method of the present invention will be exemplified with expandable polypropylene (EPP) below. As shown in FIG. 1, the molding method of the present invention includes 5 steps: silk screen printing of blister sheet, vacuum thermoforming and processing of blister sheet, foam molding of EPP (first molding), spray coating the surface of EPP foam with ink and integrate molding of EPP foam part and thermoforming part (second molding).

Step 1: silk screen printing of blister sheet

1) Silk screen printing with two layers of colour paint. Each silk screen printed layer is subjected to baking at 100° C. for 5 min.

2) Silk screen printing with three layers of EPP adhesive paint. Each silk screen printed layer is subjected to baking at 100° C. for 5 min. The next layer of ink is allowed for subsequent silk screen printing after substantially cooling. The adhesive paint is an ink for expandable polypropylene, which can adhere to EPP molded shape and thermoforming part.

Step 2: vacuum thermoforming and processing of blister sheet

1) Sheet baking. The blister sheet is subjected to baking at about 95° C. for 90 min.

2) Adjusting the parameters of the vacuum thermoforming machine. Heating temperature is about 500° C., heating period is 18 s, and cooling period is 10 s.

3) Vacuum forming a thermoforming part with specific shape by using a vacuum thermoforming mold.

4) Processing the thermoforming part, including punching and trimming.

Step 3: injection foam molding of EPP bead (first molding).

1) Adjusting the parameters of the foam-molding machine. The steam pressure is 300 kPa, the steaming period is 19 s, the cooling period is 60 s, the vacuum period is 25 s, and the temperature in the mold during molding is about 150° C.

2) Turning on the machine, filling the materials, and conducting EPP shape molding according to the parameter setting, and results in the production of an EPP foam part.

Step 4: spray coating the surface of EPP foam part with transparent ink. The ink is subjected to baking at 50° C. for 15 min. The ink is an ink for expandable polypropylene, which plays an important role in bonding the thermoforming part with EPP foam part.

Step 5: integrate molding of EPP foam part and thermoforming part (second molding)

1) Placing the EPP foam part into the thermoforming part, and then placing them together into a EPP shape molding mold.

2) Adjusting the parameters of foam-molding machine. The steam pressure of the steam chamber is 80 kPa, the period is 19 s, the water cooling period is 90 s, the vacuum period is 10 s and the temperature in the mold during molding is about 120° C., the ink can withstand at this temperature.

3) After demolding, the thermoforming part and the EPP foam part are bonded together with good appearance.

### EXAMPLE 2

The molding method of the present invention will be exemplified with modified expandable polypropylene below. The molding method of the present invention includes 5 steps: silk screen printing of blister sheet, vacuum thermoforming and processing of blister sheet, foam molding of modified expandable polypropylene (first molding), spray coating the surface of modified expandable polypropylene foam with ink, integrate molding of modified expandable polypropylene foam part and thermoforming part (second molding).

Step 1: silk screen printing of blister sheet

1) Silk screen printing with two layers of colour paint. Each silk screen printed layer is subjected to baking at 100° C. for 5 min.

2) Silk screen printing with three layers of expandable polypropylene adhesive paint. Each silk screen printed layer is subjected to baking at 100° C. for 5 min. The next layer of ink is allowed for subsequent silk screen printing after substantially cooling. The adhesive paint is an ink for expandable polypropylene, which can adhere to modified expandable polypropylene bead and thermoforming part.

Step 2: vacuum thermoforming and processing of blister sheet

1) Sheet baking. The blister sheet is subjected to baking at about 95° C. for 90 min.

2) Adjusting the parameters of the vacuum thermoforming machine. The heating temperature is about 500° C., the heating period is 18 s and the cooling period is 10 s.

3) Vacuum forming a thermoforming part with specific shape by using a vacuum thermoforming mold.

4) Processing the thermoforming part, including punching and trimming.

Step 3: injection foam molding of modified expandable polypropylene bead (first molding).

1) Adjusting the parameters of foam-molding machine. The steam pressure is 500 kPa, the steaming period is 25 s, the cooling period is 60 s, the vacuum period is 25 s and the temperature in the mold during molding is about 150° C.

2) Turning on the machine, filling the materials, and conducting the foaming of modified expandable polypropylene according to the parameter setting, and results in the production of a modified EPP foam part

Step 4: spray coating the surface of modified expandable polypropylene foam part with transparent ink. The ink is subjected to baking at 50° C. for 15 min. The ink is ink for expandable polypropylene, which plays an important role in bonding thermoforming part with foam part.

Step 5: integrate molding of modified expandable polypropylene foam part and thermoforming part (second molding)

1) Placing the modified expandable polypropylene foam part into the thermoforming part, and then placing them together into a EPPshape molding mold.

2) Adjusting the parameters of foam-molding machine. The steam pressure of the steam chamber is 100 kPa, the period is 25 s, the cooling period is 90 s, the vacuum period is 10 s, the temperature in the mold during molding is about 130° C., the ink can withstand at this temperature.

3) After demolding, the thermoforming part and the EPP foam part are boneded together with good appearance.

In step 3 of Examples 1 and 2 above, the expandable polypropylene and the modified expandable polypropylene are molded by injection foaming process. However, a skilled person in the art can understand that the expandable polypropylene and the modified expandable polypropylene can be molded with any other methods capable of producing the desired shape, such as extrusion molding, compression molding and the like

What is claimed is:

1. A molding method for expandable polypropylene, comprising the steps of silk screen printing on a blister sheet and vacuum thermoforming the printed blister sheet to provide a thermoforming part, wherein the molding method further comprises the following steps:
(1) foam molding the expandable polypropylene to provide a EPP foam part;
(2) spray coating the surface of the EPP foam part obtained in step (1) with ink; and
(3) integrate molding the EPP foam part obtained in step (2) and the thermoforming part.

2. The molding method for expandable polypropylene according to claim 1, wherein the ink is an ink for expandable polypropylene.

3. The molding method for expandable polypropylene according to claim 1 or 2, wherein the expandable polypropylene in step (1) is modified expandable polypropylene.

4. The molding method for expandable polypropylene according to claim 1 or 2, wherein the operating pressure for the integrate molding in step (3) is 80 kPa to 100 kPa and the operating temperature is 140° C. or less.

5. The molding method for expandable polypropylene according to claim 3, wherein the operating pressure for the integrate molding in step (3) is 80 kPa to 100 kPa and the operating temperature is 140° C. or less.

6. The molding method for expandable polypropylene according to claim 4, wherein the operating temperature for the integrate molding in step (3) is 120° C. to 130° C.

7. The molding method for expandable polypropylene according to claim 5, wherein the operating temperature for the integrate molding in step (3) is 120° C. to 130° C.

8. The molding method for expandable polypropylene according to claim 6 or 7, wherein the operating time for the integrate molding in step (3) is 19 s to 25 s.
